(19) United States
(12) Patent Application Publication
(10) Pub. No.: US 2012/0217663 A1
(43) Pub. Date: Aug. 30, 2012

(54) SOLAR CONCENTRATOR AND PRODUCTION METHOD

(75) Inventors: Wolfram Wintzer, Jena (DE); Peter Mühle, Jena (DE); Lars Arnold, Neustadt (DE); Alois Willke, Buseck (DE); Hagen Goldammer, Jena (DE); Andreas Baatzsch, Jena (DE)

(73) Assignee: DOCTER OPTICS GMBH, Neustadt an der Orla (DE)

(21) Appl. No.: 13/505,229

(22) PCT Filed: Oct. 14, 2010
(86) PCT No.: PCT/EP10/06279

§ 371 Date: Apr. 30, 2012

(30) Foreign Application Priority Data
Oct. 30, 2009 (DE) 10 2009 051 407.4
Aug. 30, 2010 (DE) 10 2010 035 865.7
Sep. 18, 2010 (EP) PCT/EP2010/005755

(51) Int. Cl. B29D 11/00

(52) U.S. Cl. 264/1.24

(57) ABSTRACT

The invention relates to a method for producing a solar concentrator from a transparent material. The solar concentrator comprises a light coupling surface and a light decoupling surface, the solid body comprises a supporting frame with an outer edge between the light coupling surface and the convex light decoupling surface and the transparent material is precision moulded between a first mould and a second mould to form the solar concentrator in such a way that the outer edge is moulded or formed without any or with only partial contact with said mould.

### CROSS REFERENCE TO RELATED APPLICATIONS

This application is the U.S. national phase of PCT/EP2010/006279 filed Oct. 14, 2010. PCT/EP2010/006279 claims the benefit under the Convention of German Patent Application No. 10 2009 051 407.4 filed Oct. 30, 2009 and German Patent Application No. 10 2010 035 865.7 filed Aug. 30, 2010.

### FIELD OF THE INVENTION

The invention concerns a solar concentrator made from transparent material, wherein the solar concentrator comprises a light entry (sur)face, a light exit (sur)face, and a light guide portion arranged between the light entry surface and the light exit surface (it should be noted that in context with the light entry and light exit areas described and outlined in the following specification and claims the term “face”, only, is used for the sake of simplicity and is to include the term and meaning of “surface” as well) and tapering in the direction of the light exit face. The invention, moreover, concerns a method for manufacturing such a solar concentrator.

### BACKGROUND INFORMATION

FIG. 1 shows a known solar concentrator 101 which is depicted in FIG. 2 by way of a cross-sectional representation. The solar concentrator 101 comprises a light entry face 102 and a ground light exit face 103 as well as a light guide portion 104 arranged between the light entry face 102 and the light exit face 103 and tapering in the direction of the light exit face 103. Reference numeral 105 denotes a light guide portion surface which restricts the light guide portion 104 between the light entry face 102 and the light exit face 103.

Document EP 1 396 035 B1 discloses a solar concentrator module comprising, on its frontal side, a front lens and, on its rear side, a receiver cell, and, between the front lens and the receiver cell, a reflector which has inclined side walls along at least two opposing sides of the receiver cell, and, in the center of the module, a flat vertical reflector, wherein the sidewall reflectors are shortened such that the ratio between the height H of the generator and the focal length F of the lens lies between 0.6 and 0.9.

It is an object of the invention to reduce the costs for manufacturing solar concentrators. It is a further object of the invention to produce solar concentrators of a particularly high quality within a restricted budget.

### SUMMARY

The aforementioned object is achieved by a method for producing a solar concentrator from transparent material, wherein the solar concentrator comprises a light entry face and a light exit face, wherein the solar concentrator comprises a support frame having an outer edge or rim and being situated between the light entry face and the light exit face, as well as, expediently, a light guide portion in particular tapering (linearly or non-linearly) in the direction of the light exit face, which light guide portion is in particular restricted by a light guide portion surface between the light entry face and the light exit face, and wherein the transparent material is blank molded for creating the solar concentrator, the blank molding of said material occurring between a first mold, particularly adapted for molding the light entry face, and at least one second mold especially having a particularly concave portion adapted for molding the particularly convex light exit face, and the blank molding of said material also occurring such that the outer edge or rim is molded in a manner of at least one of without contact with said mold and only partially in contact with said mold.

In the sense of the invention, a solar concentrator is, in particular, a secondary concentrator.

In the sense of the invention, transparent material is particularly glass. In the sense of the invention, transparent material is particularly silicate glass. In the sense of the invention, transparent material is particularly glass as described in Document PCT/EP2008/010136. In the sense of the invention, glass particularly comprises
0.2 to 2% by weight Al₂O₃,
0.1 to 1% by weight Li₂O,
0.3, in particular 0.4 to 1.5% by weight Sb₂O₃,
60 to 75% by weight SiO₂,
3 to 12% by weight Na₂O,
3 to 12% by weight K₂O, and/or
3 to 12% by weight CaO.

In the sense of the invention, the term blank molding is, in particular, to be understood in a manner that an optically operative surface is to be molded under pressure such that any subsequent finishing or post-treatment of the contour of this optically operative surface may be dispensed with or does not apply or will not have to be provided for, respectively. Consequently, it is particularly provided for that, after blank molding, the light exit face is not ground, i.e. it will not be treated by grinding.

A light guide portion surface, when taken in the sense of the invention, is, in particular, inclined with respect to the optical axis of the solar concentrator. An optical axis of the solar concentrator is, in particular, an orthogonal or the orthogonal, respectively, of the light exit face. The light guide portion surface may be coated.

In one embodiment of the invention, the light entry face is convex or planar. The light entry face may be shaped non-spherical or spherical. It may also be provided for that the light entry face is designed as a free form or mold. In one embodiment of the invention, the light exit face is planar. A planar light entry face or light exit face, respectively, may show a deviation of contour with respect to an ideal plane, said contour deviation being particularly due to shrinkage as well as, in particular, concave, and, for example, possibly amounting up to 20 μm or even up to 40 μm. Moreover it may be provided for that the light exit face is designed to be concave. In another embodiment of the invention, the light exit face is designed to be convex.

In the sense of the invention, a light exit face is considered to be convex particularly when its convexity extends over its whole area. In the sense of the invention, a light exit face is, in particular, considered to be convex when its convexity extends over essentially its whole area. In the sense of the invention, a light exit face is, in particular, considered to be convex when its convexity extends over at least part of its area.

In the sense of the invention, a support frame, in particular, may well be a flange. In the sense of the invention, a support frame may, in particular, be designed to be totally or at least partially circumferential. In the sense of the invention, an outer edge or rim is, in particular, that part of the solar concentrator which is situated at the farthest distance from the optical axis of the solar concentrator. In the sense of the invention, an outer edge is, in particular, that part of the solar concentrator which has the largest radial extension. In particular, it has been provided for that the support frame extends at least partially beyond the light guide portion in an orthogonal direction relative to the axis of the solar concentrator and/or that the support frame at least partially extends beyond the light guide portion radially with respect to the axis of the solar concentrator.

In the sense of the invention, a rim/outer edge is, in particular, pressed or (press-) molded, respectively, without mold contact when it does neither contact nor touch the first mold or the second mold or any other mold during its molding/formation. In the sense of the invention, a rim/outer edge is, in particular, pressed or (press-) molded, respectively, with partial mold contact, only, when, during its molding/formation, it does neither contact nor touch the first mold or the second mold or any other mold as a whole. In the sense of the invention, a rim/outer edge is, in particular, pressed or (press-) molded, respectively, with partial mold contact, only, when, during its molding/formation, merely part of its outer edge contacts or touches the first mold, the second mold or any other mold, respectively, as a whole.

It is, in particular, provided for that the transparent material be cut as liquid glass and positioned within the second mold such that the cutting grain or seam lies outside the optical area. In exerting pressure or pressure molding it is, in particular, provided for that the first mold and the second mold are positioned in relation to each other and moved to approach each other. Herein, it is possible to move the first mold towards the second mold and/or the second mold towards the first mold. The first mold and the second mold are, in particular, moved towards each other until they touch or form a closed mold entity, respectively. After exerting pressure it is, in particular, provided for that the solar concentrator be cooled on an appropriate support means on a cooling conveyor.

In an embodiment of the invention, the transparent material is drawn into the second mold by means of a depression (e.g. partial vacuum, low pressure, pressure below atmosphere, and/or underpressure). In a further embodiment of the invention, the transparent material is drawn into the second mold by means of a depression in particular at the beginning of exerting molding pressure onto the transparent material. In a further embodiment of the invention, the transparent material is, in particular in its outer region, drawn at least partially during said blank molding into the at least one second mold by means of the depression (e.g. partial vacuum, low pressure, pressure below atmosphere, and/or underpressure). In a further embodiment of the invention, the depression is at least 0.5 bar. In a further embodiment of the invention, the depression particularly corresponds to vacuum. In a further embodiment of the invention, the transparent material has a viscosity of no more than 10^{4.5} (dPa)(s), immediately before molding.

In a further embodiment of the invention, the first mold is heated and/or cooled. In a yet further preferred embodiment of the invention, the second mold is heated and/or cooled.

In a further embodiment of the invention, the second mold comprises a concave portion for molding the light exit face as a convex light exit face. In a further embodiment of the invention, the concave portion for molding the convex light exit face is curved with a radius of curvature of less than 30 mm. In a further embodiment of the invention, the concave portion for molding the convex light exit face is curved such that the maximum of the deviation of contour from the ideal plane of the mold is less than 100 μm. In a further embodiment of the invention, the concave portion for molding the convex light exit face is curved such that the maximum of the deviation of contour from the ideal plane of the mold is more than 1 μm.

In a further embodiment of the invention, the second mold is an at least two-part mold.

In a further embodiment of the invention, the second mold is an at least two-part mold. In a further embodiment of the invention, the (at least one) second mold has a gap in the region forming the transition between the light exit face and the light guide portion surface, which gap particularly is a circumferential gap, in particular an annular gap. Herein, it is, in particular, provided for that the gap is or will be formed between a first component of the second mold and a second component of the second mold. In a further embodiment of the invention, the gap has a width of between 10 μm and 40 μm. In a further expedient embodiment of the invention, the depression (e.g. partial vacuum, low pressure, pressure below atmosphere, and/or underpressure) is generated in said gap.

The aforementioned object is, moreover, achieved by a method for producing a solar module, wherein a solar concentrator produced by a method according to any one of the preceding features is, with its light exit face, connected to, in particular cemented to a photovoltaic element (for generating electric energy from sunlight), and/or is fixedly aligned with respect to a photovoltaic element (for generating electric energy from sunlight).

The aforementioned object is, furthermore, achieved by a solar concentrator in particular produced in accordance with a method according to any one of the preceding features and having a solid body from transparent material, which body comprises a light entry face and a particularly convex light exit face, wherein the solid body comprises a support frame situated between the light entry face and the light exit face, as well as, expediently, a light guide portion, in particular tapering (linearly or non-linearly) in the direction of the light exit face, which light guide portion is restricted by a light guide portion surface between the light entry face and the light exit face, and wherein the support frame comprises a rim/outer edge press-molded without contact with a mold or only partially in contact with a mold.

In an embodiment of the invention, the light guide portion surface merges into the convex light exit face with a continuous first derivative. In a further embodiment of the invention, the light guide portion surface merges into the convex light exit face with a curvature, the radius of which is no more than 0.25 mm, in particular no more than 0.15 mm, in particular no more than 0.1 mm. In a further embodiment of the invention, the radius of curvature is more than 0.04 mm.

In an embodiment of the invention, the light exit face is curved convexly. In an embodiment of the invention, the convex light exit face is curved with a curvature of more than 30 mm. In an embodiment of the invention, the light exit face is curved such that its (maximum) deviation of contour from the ideal plane or the light exit face, respectively, is less than 100 μm. In the sense of the invention, an ideal plane is, in particular, a plane through the transition of the light guide portion surface to the light exit face. In the sense of the invention, a light exit plane is, in particular, a plane through the transition of the light guide portion surface to the light exit face. In the sense of the invention, a light exit plane is, in particular, a plane parallel to the plane through the transition of the light guide portion surface to the light exit face, when placed through the apex (of the curvature) of the light exit face. In the sense of the invention, a light exit plane is, in particular, a plane orthogonal to the tapering light guide portion when placed through the apex (of the curvature) of the light exit face. In the sense of the invention, a light exit plane is, in particular, a plane orthogonal to the optical axis of the solar concentrator when placed through the apex (of the curvature) of the light exit face. In an embodiment of the invention, the light exit face is curved such that its (maximum) deviation of contour from the ideal plane or the light exit face, respectively, is more than 1 μm.

In a further embodiment of the invention, the light exit face is blank molded. In a further embodiment of the invention, the particularly curved transition to from the light guide portion surface into the light exit face is blank molded. In a further embodiment of the invention, the light entry face is blank molded. The light entry face may be shaped non-spherical or spherical.

In a further embodiment of the invention, the solar concentrator has a mass is of between 2 g and 50 g.

The aforementioned object is, furthermore, achieved by a solar module comprising an aforementioned solar concentrator or a solar concentrator produced in accordance with any of the aforementioned methods, respectively, from transparent material, wherein the solar concentrator, with its light exit face, is connected, in particular cemented to a photovoltaic element.

In an embodiment of the invention, the solar module comprises a heat sink body on which the photovoltaic element is mounted. In a further embodiment of the invention, a retention system for the solar concentrator is arranged on the heat sink body.

In a further embodiment of the invention, the solar module comprises a retention system for the solar concentrator.

In a further embodiment of the invention, the retention system fixedly attaches the solar concentrator to the support frame. In a further embodiment of the invention, the solar module comprises a lens for directing sunlight onto the light entry face of the solar concentrator or a primary solar concentrator for directing sunlight onto the light entry face of the solar concentrator, respectively.

The invention furthermore concerns method for generating electric energy, wherein sunlight is made to enter into the light entry face of a solar concentrator of an aforementioned solar module, in particular by means of a primary solar concentrator.

The invention furthermore concerns method for generating electric energy, wherein sunlight is made to enter into the light entry face of an aforementioned solar concentrator, in particular by means of a primary solar concentrator.

The aforementioned object is, furthermore, achieved by a method for producing a solar concentrator from transparent material, wherein the solar concentrator comprises a light entry face, a light exit face and a light guide portion arranged between the light entry face and the light exit face and tapering (linearly or non-linearly) in the direction of the light exit face, which light guide portion is restricted by a light guide portion surface between the light entry face and the light exit face, wherein, between a first mold, adapted for molding the light entry face, and at least one second mold, adapted for molding the light exit face, the transparent material is blank molded, in particular two-sidedly, for creating the solar concentrator, and wherein the transparent material, particularly at the beginning of exerting molding pressure onto the transparent material, is drawn into the second mold by means of a depression, i.e. pressure below atmosphere.

In the sense of the invention, a solar concentrator is a secondary concentrator.

In the sense of the invention, transparent material is particularly glass. In the sense of the invention, transparent material is particularly silicate glass. In the sense of the invention, transparent material is particularly glass as described in Document PCT/EP2008/010136. In the sense of the invention, glass particularly comprises
0.2 to 2% by weight Al₂O₃,
0.1 to 1% by weight Li₂O,
0.3, in particular 0.4 to 1.5% by weight Sb₂O₃,
60 to 75% by weight SiO₂,
3 to 12% by weight Na₂O,
3 to 12% by weight K₂O, and/or
3 to 12% by weight CaO.

In the sense of the invention, the term blank molding is, in particular, to be understood in a manner that an optically operative surface is to be molded under pressure such that any subsequent finishing or post-treatment of the contour of this optically effective surface may be dispensed with or does not apply or will not have to be provided for, respectively. Consequently, it is particularly provided for that, after blank molding, the light exit face is not ground, i.e. it will not be treated by grinding.

A light guide portion surface, when taken in the sense of the invention, is, in particular, inclined with respect to the optical axis of the solar concentrator. An optical axis of the solar concentrator is, in particular, an orthogonal or the orthogonal, respectively, of the light exit face. The light guide portion surface may be coated.

It is, in particular, provided for that the transparent material be cut as liquid glass and positioned within the second mold such that the cutting grain or seam lies outside the optical area. In context with exerting pressure it is, in particular, provided for that the first mold and the second mold are positioned in relation to each other and moved to approach each other. After applying pressure (molding) it is, in particular, provided for that the solar concentrator be cooled on an appropriate support means on a cooling conveyor. In a preferred embodiment the solar concentrator has a support frame.

In a further preferred embodiment of the invention, the transparent material, in particular in the outer region of the material is drawn into the second mold by means of the depression (e.g. partial vacuum, low pressure, pressure below atmosphere, and/or underpressure) at least partially during said blank molding. In a yet further preferred embodiment of the invention, the depression is at least 0.5 bar. In a yet further preferred embodiment of the invention, the depression corresponds, in particular, to vacuum. In a yet further preferred embodiment of the invention, the transparent material has a viscosity of no more than 10^{4.5} (dPa)(s) immediately before molding.

In a further embodiment of the invention, the first mold is heated and/or cooled. In a yet further preferred embodiment of the invention, the second mold is heated and/or cooled.

In a further favorable embodiment of the invention, the second mold is at least two-part. In a further preferred embodiment of the invention, the second mold has a gap, particularly a circumferential gap, specifically an annular gap, in the region forming the transition between the light exit face and the light guide portion surface. Herein, it is, in particular, provided that the gap is or will be formed, respectively, retention system between a first component of the second mold and a second component of the second mold. In a yet further embodiment of the invention the gap has a width of between 10 μm and 40 μm. In a further expedient embodiment of the invention, the depression (e.g. partial vacuum, low pressure, pressure below atmosphere, and/or underpressure) is generated in said gap.

The aforementioned object is, moreover, achieved by a method for producing a solar module, wherein a solar concentrator produced by a method according to any one of the preceding features is, with its light exit face, connected to, in particular cemented to a photovoltaic element (for generating electric energy from sunlight), and/or is fixedly aligned with respect to a photovoltaic element (for generating electric energy from sunlight).

The aforementioned object is, furthermore, achieved by a solar concentrator in particular produced in accordance with a method according to any one of the preceding features and having a solid body from transparent material, which comprises a light entry face and a light exit face, wherein the solid body comprises a light guide portion between the light entry face and the light exit face tapering (linearly or non-linearly) in the direction of the light exit face, which light guide portion is restricted between the light entry face and the light exit face by a light guide portion surface, and wherein the light guide portion surface merges into the light exit face with a continuous first derivative.

The aforementioned object is, furthermore, achieved by a solar concentrator in particular produced in accordance with a method according to any one of the preceding features and made from transparent material, wherein the solar concentrator comprises a light entry face, a light exit face, and a light guide portion arranged between the light entry face and the light exit face and tapering (linearly or non-linearly) in the direction of the light exit face, which light guide portion is restricted between the light entry face and the light exit face by a light guide portion surface, and wherein the light guide portion surface merges into the light exit face with a continuous first derivative.

In an embodiment of the invention the light guide portion surface merges into the light exit face with a curvature the radius of which amounts to no more than 0.25 mm, in particular to no more than 0.15 mm, preferably to no more than 0.1 mm.

The aforementioned object is, in addition, achieved by a solar concentrator in particular produced in accordance with a method according to any one of the preceding features and having a solid body from transparent material, which comprises a light entry face and a light exit face, wherein the solid body comprises a light guide portion arranged between the light entry face and the light exit face and tapering (linearly or non-linearly) in the direction of the light exit face, which light guide portion is restricted by a light guide portion surface between the light entry face and the light exit face, and wherein the light guide portion surface merges into the light exit face with a curvature, the radius of curvature of which is no more than 0.25 mm, in particular no more than 0.15 mm, preferably no more than 0.1 mm.

The aforementioned object is, furthermore, achieved by a solar concentrator in particular produced in accordance with a method according to any one of the preceding features and made from transparent material, which solar concentrator comprises a light entry face, a light exit face, and a light guide portion arranged between the light entry face and the light exit face and tapering (linearly or non-linearly) in the direction of the light exit face, which light guide portion is restricted by a light guide portion surface between the light entry face and the light exit face, and wherein the light guide portion surface merges into the light exit face with a curvature, the radius of curvature of which light exit face is no more than 0.25 mm, in particular no more than 0.15 mm, preferably no more than 0.1 mm.

In a further expedient embodiment of the invention the radius of curvature is more than 0.04 mm. In a yet further preferred embodiment of the invention the light exit face is blank molded. In a still further embodiment of the invention the preferably curved transition from the light guide portion surface into the light exit face is blank molded.

In a further preferred embodiment of the invention, the light entry face is blank molded. In a yet further preferred embodiment of the invention, the light entry face is convex or planar. The light entry face may be shaped to be non-spherical or spherical. In one embodiment of the invention, the light exit face is planar. A planar light entry face or light exit face, respectively, may show a particularly shrinkage-based, in particular concave deviation of contour with respect to an ideal plane, which deviation may for example amount up to 20 μm or even up to 40 μm. It may also be provided for that the light entry face be designed as a free form. Moreover it may be provided for that the light exit face be designed to be concave. In an embodiment of the invention, however, the light exit face is designed to be convex.

The aforementioned object is, in addition, achieved by a solar concentrator in particular produced in accordance with a method according to any one of the preceding features and having a solid body from transparent material, which comprises a light entry face and a light exit face, wherein the solid body comprises a light guide portion arranged between the light entry face and the light exit face and tapering (linearly or non-linearly) in the direction of the light exit face, and wherein the light exit face is blank molded.

The aforementioned object is, furthermore, achieved by a solar concentrator in particular produced in accordance with a method according to any one of the preceding features and made from transparent material, which solar concentrator comprises a light entry face, a light exit face, and a light guide portion arranged between the light entry face and the light exit face and tapering (linearly or non-linearly) in the direction of the light exit face, and wherein the light exit face is blank molded.

In a further preferred embodiment of the invention, the light entry face is blank molded. In a yet further preferred embodiment of the invention, the light entry face is convex or planar. The light entry face may be shaped non-spherical or spherical. In one embodiment of the invention, the light exit face is planar. A planar light entry face or light exit face, respectively, may show a particularly shrinkage-based, in particular concave deviation of contour with respect to an ideal plane, which deviation may for example amount up to 20 μm or even up to 40 μm. It may also be provided that the light entry face is designed as a free form. Moreover it may be provided that the light exit face is designed to be concave. In an embodiment of the invention, however, the light exit face is designed to be convex.

The aforementioned object is achieved by a method for producing a solar concentrator from transparent material, wherein the solar concentrator comprises a light entry face, a convex light exit face and a light guide portion arranged between the light entry face and the convex light exit face and tapering (linearly or non-linearly) in the direction of the light exit face, which light guide portion is in particular restricted by a light guide portion surface between the light entry face and the convex light exit face, and wherein, between a first mold, adapted for molding the light entry face, and at least one second mold, having a concave portion for molding the convex light exit face, the transparent material is blank molded, in particular two-sidedly, for creating the solar concentrator, wherein the transparent material, particularly at the beginning of exerting the molding pressure onto the transparent material, is drawn into the second mold by means of a depression, i.e. pressure below atmosphere.

In the sense of the invention, a solar concentrator is, in particular, a secondary concentrator. In the sense of the invention, transparent material is particularly glass.

In the sense of the invention, transparent material is particularly glass. In the sense of the invention, transparent material is, in particular, silicate glass. In the sense of the invention, transparent material is particularly glass as described in Document PCT/EP2008/010136. Glass, in the sense of the invention, particularly comprises
0.2 to 2% by weight Al₂O₃,
0.1 to 1% by weight Li₂O,
0.3, in particular 0.4 to 1.5% by weight Sb₂O₃,
60 to 75% by weight SiO₂,
3 to 12% by weight Na₂O,
3 to 12% by weight K₂O, and/or
3 to 12% by weight CaO.

In the sense of the invention, the term blank molding is, in particular, to be understood in a manner that an optically operative surface is to be molded under pressure such that any subsequent finishing or post-treatment of the contour of this optically effective surface may be dispensed with or does not apply or will not have to be provided for, respectively. Consequently, it is particularly provided for that, after blank molding, the light exit face is not ground, i.e. it will not be treated by grinding.

A light guide portion surface, when taken in the sense of the invention, is, in particular, inclined with respect to the optical axis of the solar concentrator. An optical axis of the solar concentrator is, in particular, an orthogonal or the orthogonal, respectively, of the light exit face. The light guide portion surface may be coated.

In the sense of the invention, a light exit face is considered to be convex particularly when its convexity extends over its whole area. In the sense of the invention, a light exit face is, in particular, considered to be convex when its convexity extends over essentially its whole area. In the sense of the invention, a light exit face is, in particular, considered to be convex when its convexity extends over at least part of its area.

It is, in particular, provided for that the transparent material be cut as liquid glass and positioned within the second mold such that the cutting grain or seam lies outside the optical area. In context with exerting pressure it is, in particular, provided for that the first mold and the second mold are positioned in relation to each other and moved to approach each other. After applying pressure (molding) it is, in particular, provided for that the solar concentrator be cooled on an appropriate support means on a cooling conveyor. In a preferred embodiment the solar concentrator has a support frame.

In a further embodiment of the invention, the transparent material is, in particular in the outer region of the material drawn into the second mold by means of the depression at least partially during said blank molding. In a yet further preferred embodiment of the invention, the depression is at least 0.5 bar. In a yet further embodiment of the invention, the depression corresponds, in particular, to vacuum. In a yet further embodiment of the invention, the transparent material has a viscosity of no more than 10^{4.5} (dPa)(s) immediately before molding.

In a further embodiment of the invention, the concave portion for molding the convex light exit face is curved with a radius of curvature of less than 30 mm. In a further embodiment of the invention, the concave portion for molding the convex light exit face is curved such that the (maximum) deviation of contour from the ideal plane of the mold is less than 100 μm. In the sense of the invention, an ideal plane of the mold is, in particular, a plane through the transition of the portion (in particular of the second mold) provided for molding the light guide portion surface, into the portion for molding the convex light exit face. In a further embodiment of the invention, the concave portion for molding the convex light exit face is curved such that the (maximum) deviation of contour from the ideal plane of the mold is more than 1 μm.

In a further embodiment of the invention, the first mold is heated and/or cooled. In a yet further preferred embodiment of the invention, the second mold is heated and/or cooled.

In a further embodiment of the invention, the second mold is an at least two-part mold. In a further embodiment of the invention, the second mold has a gap in the region forming the transition between the light exit face and the light guide portion surface, which gap, in particular, is a circumferential gap, in particular an annular gap. Herein, it is, in particular, provided for that the gap is or will be, respectively, formed between a first portion of the second mold and a second portion of the second mold. In a further embodiment of the invention, the gap has a width of between 10 μm and 40 μm. In a further expedient embodiment of the invention, the depression is generated in said gap.

The aforementioned object is, moreover, achieved by a method for producing a solar module, wherein a solar concentrator produced in accordance with a method according to any one of the preceding features is, with its light exit face, connected to, in particular cemented to a photovoltaic element (for generating electric energy from sunlight), and/or is fixedly aligned with respect to a photovoltaic element (for generating electric energy from sunlight).

The aforementioned object is, furthermore, achieved by a solar concentrator in particular produced in accordance with a method according to any one of the preceding features and having a solid body from transparent material, which body comprises a light entry face and a convex light exit face, wherein the solid body comprises a light guide portion (linearly or non-linearly) tapering in the direction of the convex light exit face and situated between the light entry face and the convex light exit face, which light guide portion is in particular restricted by a light guide portion surface and arranged, respectively, between the light entry face and the convex light exit face.

The aforementioned object is, furthermore, achieved by a solar concentrator in particular produced in accordance with a method according to any one of the preceding features and made of transparent material, which solar concentrator comprises a light entry face, a convex light exit face and a light guide portion (linearly or non-linearly) tapering in the direction of the convex light exit face and situated between the light entry face and the convex light exit face, which light guide portion is in particular restricted by a light guide portion surface and arranged, respectively, between the light entry face and the convex light exit face.

In an embodiment of the invention, the light guide portion surface merges into the convex light exit face with a continuous first derivative. In a further embodiment of the invention, the light guide portion surface merges into the convex light exit face with a curvature, the radius of which curvature is no more than 0.25 mm, in particular no more than 0.15 mm, in particular no more than 0.1 mm. In a further embodiment of the invention, the radius of curvature is more than 0.04 mm.

In an embodiment of the invention, the convex light exit face is curved with a curvature of more than 30 mm. In an embodiment of the invention, the light exit face is curved such that its (maximum) deviation of contour from the ideal plane or the light exit face, respectively, is less than 100 μm. In the sense of the invention, an ideal plane is, in particular, a plane through the transition of the light guide portion surface into the light exit face. In the sense of the invention, a light exit plane is, in particular, a plane through the transition of the light guide portion surface to the light exit face. In the sense of the invention, a light exit plane is, in particular, a plane parallel to the plane through the transition of the light guide portion surface into the light exit face, when said plane is placed through the apex (of the curvature) of the light exit face. In the sense of the invention, a light exit plane is, in particular, a plane orthogonal to the tapering light guide portion when said plane is placed through the apex (of the curvature) of the light exit face. In the sense of the invention, a light exit plane is, in particular, a plane orthogonal to the optical axis of the solar concentrator when said plane is placed through the apex (of the curvature) of the convex light exit face. In an embodiment of the invention, the light exit face is curved such that its (maximum) deviation of contour from the ideal plane or the light exit plane, respectively, is more than 1 μm.

In a further embodiment of the invention, the convex light exit face is blank molded. In a further embodiment of the invention, the particularly curved transition from the light guide portion surface into the light exit face is blank molded. In a further embodiment of the invention, the light entry face is blank molded. In a further embodiment of the invention, the light entry face is convex or planar. The light entry face may be shaped non-spherical or spherical. It may also be provided that the light entry face is designed as a free form. The light exit face may be designed to be spherical or non-spherical. It may also be provided that the light exit face is designed as a free form.

The aforementioned object is, furthermore, achieved by a solar module comprising an aforementioned solar concentrator or a solar concentrator from transparent material and produced in accordance with any of the aforementioned methods, respectively, wherein the solar concentrator, by means of its light exit face is connected to a photovoltaic element.

The invention furthermore concerns method for generating electric energy, wherein sunlight is made to enter into the light entry face of a solar concentrator of an aforementioned solar module, in particular by means of a primary solar concentrator.

The aforementioned object is, furthermore, achieved by a method for producing a solar concentrator from transparent material, wherein the solar concentrator comprises a light entry face, a light exit face and a light guide portion arranged between the light entry face and the light exit face and, in particular, tapering in the direction of the light exit face, which light guide portion is restricted by a light guide portion surface between the light entry face and the light exit face, wherein, between a first mold, in particular adapted for molding the light entry face, and at least one second mold, in particular adapted for molding the light exit face, the transparent material is blank molded for creating the solar concentrator, wherein the second mold has a perforation at which (or at whose side facing away from the liquid glass) a depression, i.e. pressure below atmosphere is generated so that the transparent material is drawn into the second mold by means of the depression (being effective through the perforation).

In the sense of the invention, a solar concentrator is a secondary concentrator.

In the sense of the invention, transparent material is particularly glass. In the sense of the invention, transparent material is particularly silicate glass. In the sense of the invention, transparent material is particularly glass as described in Document PCT/EP2008/010136. In the sense of the invention, glass, in particular, comprises
0.2 to 2% by weight Al₂O₃,
0.1 to 1% by weight Li₂O,
0.3, in particular 0.4 to 1.5% by weight Sb₂O₃,
60 to 75% by weight SiO₂,
3 to 12% by weight Na₂O,
3 to 12% by weight K₂O, and/or
3 to 12% by weight CaO.

In the sense of the invention, the term blank molding is, in particular, to be understood in a manner that an optically operative surface is to be molded under pressure such that any subsequent finishing or post-treatment of the contour of this optically effective surface may be dispensed with or does not apply or will not have to be provided for, respectively. Consequently, it is particularly provided for that, after blank molding, the light exit face is not ground, i.e. it will not be treated by grinding.

In the sense of the invention, a perforation is, in particular, a perforation generated by means of a laser (laser perforation). In the sense of the invention, a perforation comprises a plurality of holes. In the sense of the invention, a plurality of holes means at least 10, in particular at least 20, in particular at least 50. In the sense of the invention, a perforation in particular includes, in particular, at least 50 holes. The following applies, in particular, for a perforation as suggested within the sense of the invention:

$$X \leq {\sum }_{i = 1}^{n} Q ( {L}_{i} ) \leq Y$$

Herein, Lᵢ designates the number “i” hole of a perforation comprising n holes, Q(Lᵢ) designates the cross-sectional face or the minimum cross-sectional face, respectively, of the number “i” hole of the perforation. In the sense of the invention, X is, in particular, 0.1 mm², particularly 0.2 mm². Y, in particular, amounts to 1 mm².

It is, in particular, provided for that the transparent material be cut as liquid glass and positioned within the second mold such that the cutting grain or seam lies outside the optical area. In context with exerting pressure it is, in particular, provided for that the first mold and the second mold are positioned in relation to each other and moved to approach each other. Herein, it is possible to move the first mold towards the second mold and/or the second mold towards the first mold. The first mold and the second mold are, in particular, moved towards each other until they touch or form a closed mold entity, respectively. After applying pressure (molding) it is, in particular, provided for that the solar concentrator be cooled on an appropriate support means on a cooling conveyor.

In an embodiment of the invention, the transparent material is drawn, due to the position and/or the design of the perforation in its outer region, into the at least one second mold by means of the depression. In an embodiment of the invention, the transparent material is drawn, in particular in its outer region, at least partially during said blank molding into the second mold by means of the depression. In a further embodiment of the invention, the depression is at least 0.5 bar. In a further embodiment of the invention, the depression particularly corresponds to vacuum. In a further embodiment of the invention the transparent material has a viscosity of no more than 10^{4.5} (dPa)(s) immediately before exerting pressure (molding).

In a further embodiment of the invention, the first mold is heated and/or cooled. In a yet further embodiment of the invention, the second mold is heated and/or cooled.

In a further embodiment of the invention, the light entry face is convex or planar. The light entry face may be shaped non-spherical or spherical. In one embodiment of the invention, the light exit face is convex or planar. A planar light entry face or light exit face, respectively, may show a particularly shrinkage-based, in particular concave deviation of contour with respect to an ideal plane, which deviation may for example amount up to 20 μm or even up to 40 μm. It may also be provided that the light entry face is designed as a free form. Moreover it may be provided that the light exit face is designed to be concave.

In a further embodiment of the invention, the second mold has a plate including the perforation. In the sense of the invention, a plate may well be, in particular, a film or foil. In an embodiment of the invention, the plate is made from metal, in particular from steel or from Nimonic. The plate may be coated with e.g. chromium.

In a further embodiment of the invention, the light exit face is formed or shaped by means of the plate. In particular, this means that while pressure is being exerted onto the light exit face, the latter contacts or touches the plate and thereby obtains its shape.

In a further embodiment of the invention, the perforation is arranged on the circumference of a geometric figure. In the sense of the invention, a geometric figure is, in particular, a circle or a square. In a further embodiment of the invention, the geometric figure, on whose circumference the perforation is arranged, is the same geometric figure as the light exit plane or the projection of the light exit plane in the direction of the orientation of the optical axis of the solar concentrator. An optical axis of the solar concentrator is, in particular, an orthogonal or the orthogonal, respectively, of the light exit face. In a further embodiment of the invention, the geometric figure, on whose circumference the perforation is arranged, is the same geometric figure as the light exit plane or the projection of the light exit plane in the direction of the orientation of the optical axis of the solar concentrator, wherein the area of the geometric figure, on whose circumference the perforation is arranged, is by between 1% and 3% larger than the area of the geometric figure of the light exit plane or the projection of the light exit plane in the direction of the orientation of the optical axis of the solar concentrator.

The aforementioned object is, furthermore, achieved by a method—in particular comprising one or several of the aforementioned features—for producing a solar concentrator—in particular comprising one or several of the aforementioned features—from transparent material, wherein the solar concentrator comprises a light entry face, a light exit face and a light guide portion arranged between the light entry face and the light exit face and, in particular, tapering in the direction of the light exit face, which light guide portion is restricted by a light guide portion surface between the light entry face and the light exit face, wherein, between a first mold, in particular adapted for molding the light entry face, and at least one second mold, in particular adapted for molding the light exit face, the transparent material is blank molded for creating the solar concentrator, wherein the second mold has a plate including a perforation.

The aforementioned object is, moreover, achieved by a method for producing a solar module, wherein a solar concentrator produced in accordance with a method according to any one of the preceding features is, with its light exit face, connected to, in particular cemented to a photovoltaic element (for generating electric energy from sunlight), and/or is fixedly aligned with respect to a photovoltaic element (for generating electric energy from sunlight).

The aforementioned object is, furthermore, achieved by a method for generating electric energy, wherein sunlight is made to enter into the light entry face of a solar concentrator of an aforementioned solar module.

Further advantages and details of the present invention will become apparent from the following description of preferred examples of embodiment.

### BRIEF DESCRIPTION OF THE DRAWINGS

FIG. 1 shows a perspective representation of a known solar concentrator;

FIG. 2 shows a cross-sectional representation of the solar concentrator as shown in FIG. 1;

FIG. 3 shows an example of embodiment of a solar concentrator according to the present invention;

FIG. 4 shows a method for manufacturing a solar concentrator according to FIG. 3;

FIG. 5 shows an enlarged cut-out of a solar concentrator according to FIG. 3;

FIG. 6 shows an alternative method for manufacturing a solar concentrator according to FIG. 3;

FIG. 7 shows an example of embodiment of a solar module with a solar concentrator according to the present invention;

FIG. 8 shows a further method for producing a solar concentrator; and

FIG. 9 shows a further method for producing a solar concentrator.

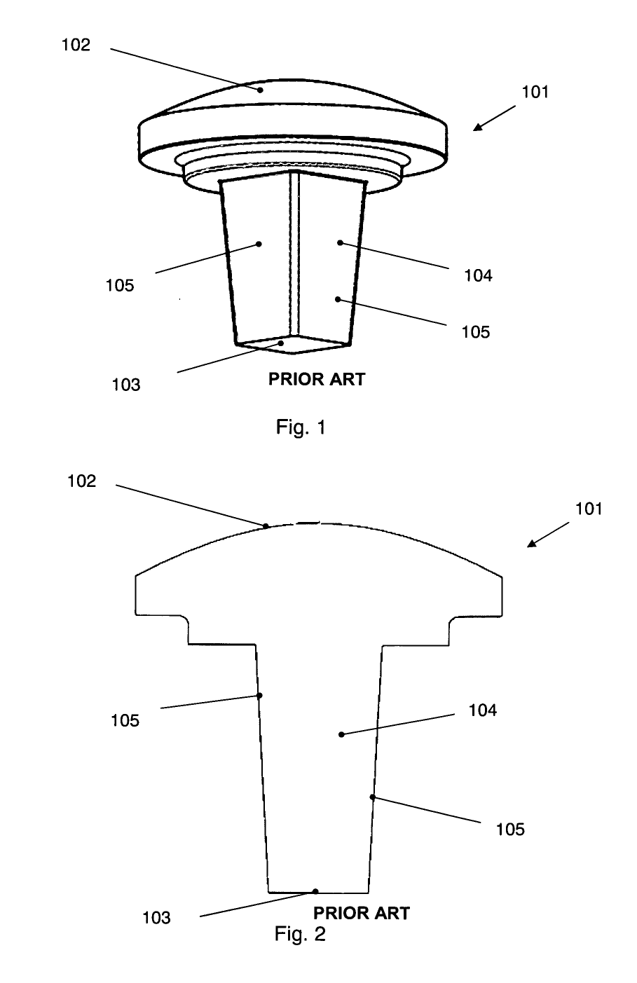

### DETAILED DESCRIPTION

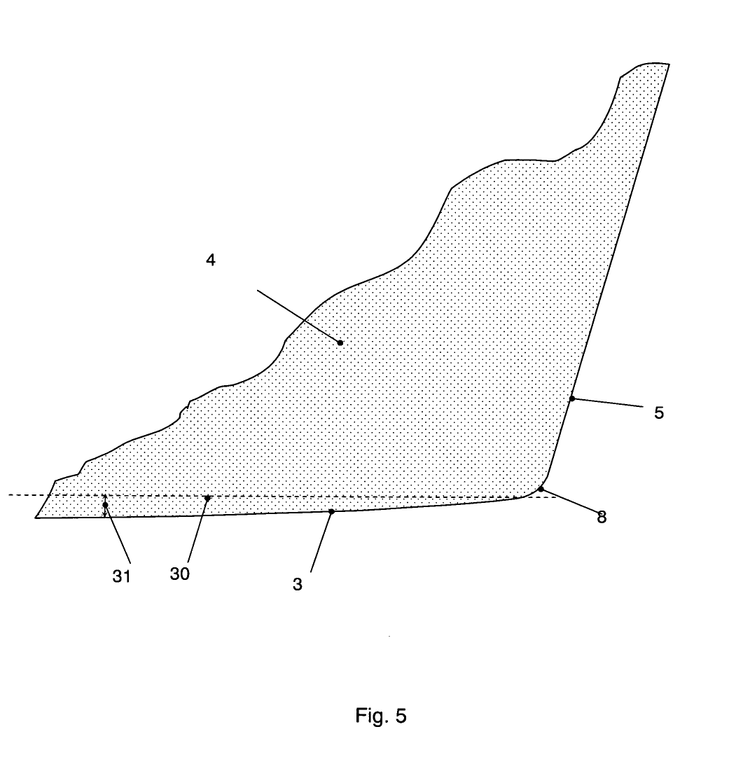

FIG. 3 shows, by way of a cross-sectional representation, an example of embodiment of a solar concentrator 1 according to the present invention. The solar concentrator comprises a light entry (sur)face 2 and a blank-molded light exit (sur)face 3 as well as a light guide portion 4 arranged between the light entry face 2 and the light exit face 3 and tapering in the direction of the light exit face 3. Reference numeral 5 designates a blank-molded light guide portion surface which restricts the light guide portion 4 between the light entry face 2 and the light exit face 3. Herein, the light guide portion surface 5 merges—as has been represented in greater detail in FIG. 5—into the light exit face with a curvature 8 whose radius of curvature is approximately 0.1 mm. The solar concentrator 1 moreover comprises a support frame 61 between the light entry face 2 and the light exit face 3 or between the light entry face 2 and the light guide portion 5, respectively. The support frame 61 comprises a rim/outer edge 62. Herein, the outer edge or rim 62 is that part/region/portion of the solar concentrator 1 which is furthest away from the optical axis 60 thereof.

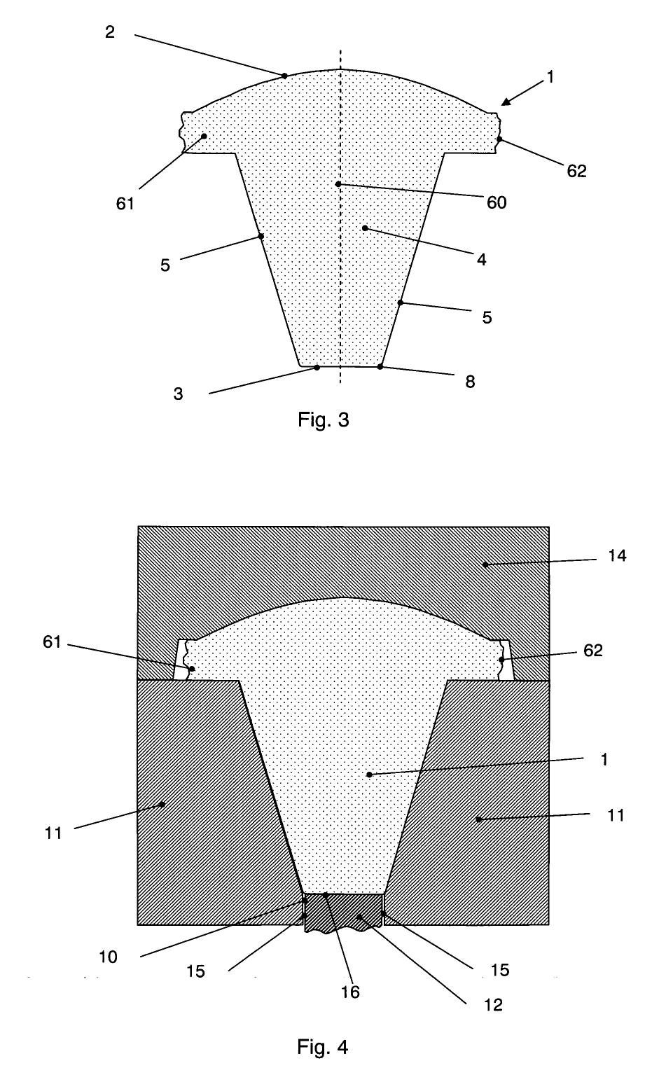

The outer edge or rim 62 represented in FIG. 3 has been press-molded, i.e. molded under pressure without mold contact as has been described in detail with reference to FIG. 4. In this context, FIG. 4 shows a method for manufacturing a solar concentrator 1 according to FIG. 3, wherein liquid glass having a viscosity of no more than 10^{4.5} (dPa)(s) is fed into a mold 10 and, by means of a mold 14, pressed and molded under pressure, respectively, into the shape of the solar concentrator 1. The mold 10 comprises a partial mold 11 and a partial mold 12 which, in a centered manner, is arranged within the partial mold 11. A circumferential gap 15 is provided between the partial mold 11 and the partial mold 12, which gap has a width of between 10 μm and 40 μm. In the circumferential gap 15 a depression in the order of a vacuum is generated when pressing together the molds 10 and 14. The partial mold 12 comprises a concave portion 16 for forming the convex light exit face 3. For exerting pressure either the partial mold 11 is moved towards the mold 14, or the mold 14 is moved towards the partial mold 11. However, it may also be provided for that both molds are moved. The partial mold 11 and/or the mold 14, respectively, are moved until the partial mold 11 and the mold 14 touch and/or until the mold 14 firmly becomes seated on the partial mold 11 and a closed mold entity is formed, as has been represented in FIG. 4. The support frame 61 is pressed between the partial mold 11 and the mold 14 in such a manner that an outer edge or rim 62 has no mold contact, which means it has no contact with either the mold 14 or the partial mold 11.

In an embodiment the convex light exit face 3 is curved with a curvature of more than 30 mm or such, respectively, that the maximum of its contour deviation 31 from the ideal plane or the light exit face 30, respectively, is less than 100 μm. In the present example of embodiment the convex light exit face 3 is curved such that the maximum of its contour deviation 31 from the ideal plane or the light exit face 30, respectively, is less than 100 μm.

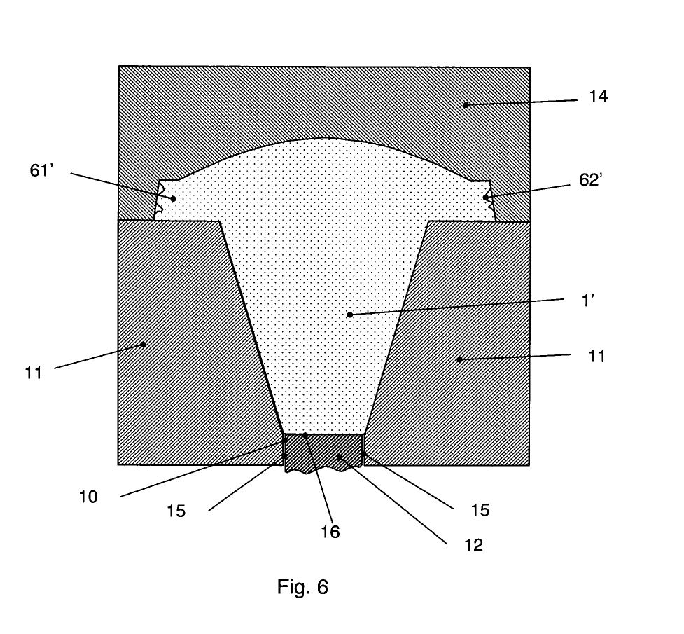

FIG. 6 shows an optional or modified method for manufacturing a solar concentrator 1′. Herein reference numeral 61′ designates a support frame of the solar concentrator 1′ and reference numeral 62′ designates an outer edge or rim of the support frame 61′. Same reference numerals as in FIG. 4 designate similar elements and/or objects, respectively. In modification of the method described with reference to FIG. 4, the outer edge/rim 62′ is pressed such that it has partial mold contact, i.e. that—in the present example of embodiment—it partially touches the mold 14. The outer edge 62′ of the support frame 61′ does, however, not contact the partial mold 14 completely, i.e. it has no complete mold contact. Thus, the mold contact of the outer edge/rim 62′ only exists partially.

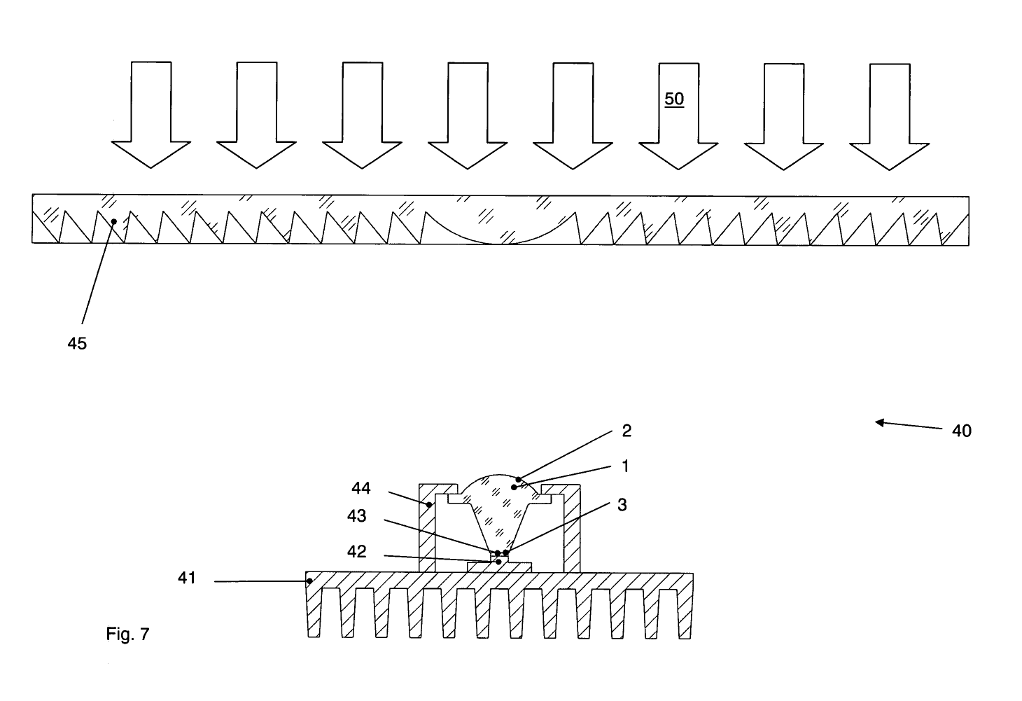

FIG. 7 shows an example of embodiment of a solar module 40 including a solar concentrator 1 in accordance with the invention. The solar module 40 comprises a cooling body 41 on which there is arranged a photovoltaic element 42 and a retention system 44 for the solar concentrator 1. The light exit face 3 is connected to the photovoltaic element 42 by means of a layer 43 of adhesive material. The solar module 40 furthermore comprises a primary solar concentrator 45 designed as a Fresnel or drum lens for aligning sunlight 50 with the light entry face 2 of the solar concentrator 1 arranged or designed or provided, respectively, as a secondary solar concentrator. Sunlight fed into the solar concentrator 1 via the light entry face 2 exits via the light exit face 3 of the solar concentrator 1 and encounters the photovoltaic element 42.

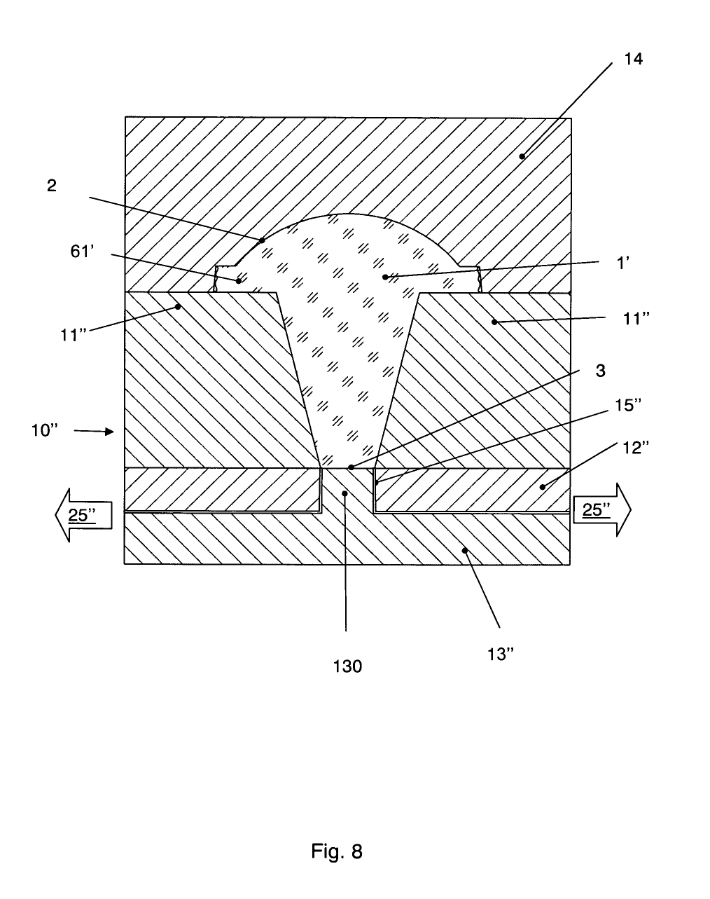

FIG. 8 shows a further method optional or modified, respectively, with regard to the method described with reference to FIG. 4 and FIG. 6, respectively, wherein same reference numerals as in FIG. 4 or FIG. 6 designate similar objects, respectively. In place of the partial mold 11 a partial mold 11″ is used, below which there is arranged a plate 12″ having a bore. Below the plate 12 there is arranged a plate 13″ having a die 130 engaging with the bore of the plate 12″. A circumferential gap 15″ is formed between the die 130 and the bore, which gap 15″ corresponds to the gap 15 in FIG. 4 and FIG. 6, respectively, but continues along the border area between the plate 12″ and the plate 13″, if necessary by means of an appropriate duct. By applying a depression 25″ at the border area a corresponding depression is generated in the gap 15″ so that liquid glass is drawn into the partial mold 11″ in a manner analogue to what has been described with reference to FIG. 4 and FIG. 6.

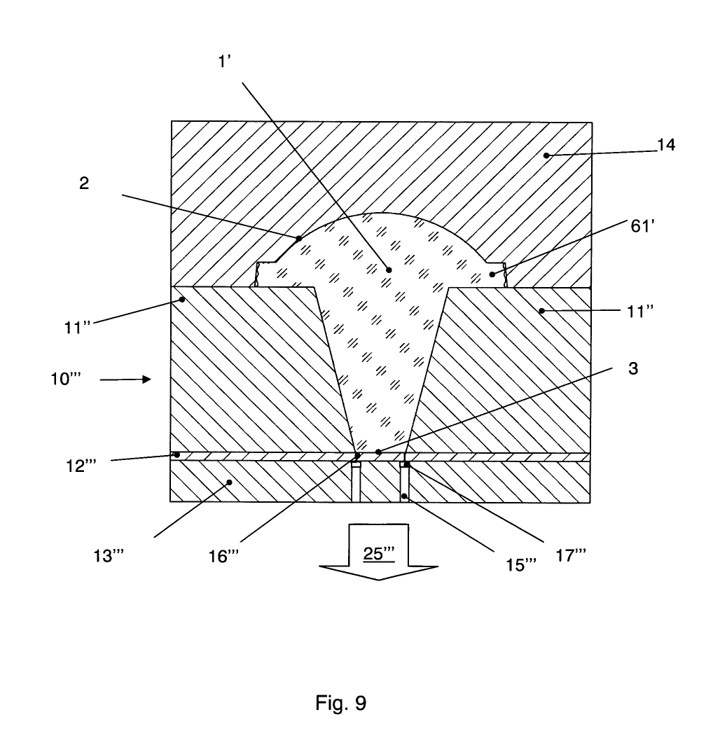

FIG. 9 shows a further method optional or modified, respectively, with regard to the method described with reference to FIG. 4 and FIG. 6 and FIG. 8, respectively, wherein same reference numerals as in FIG. 4, FIG. 6 and FIG. 8 designate similar objects, respectively. The mold 10′″ used for blank molding comprises a partial mold 11′″, a support plate 13′″ as well as a plate 12′″ arranged between the support plate 13′″ and the partial mold 11′″. The plate 12′″ may well be a film or foil. The plate 12′″ comprises a perforation 16′″. The perforation 16′″, in the present example of embodiment, comprises, within the plate 12′″, 108 holes arranged along the circumference of a square which are arranged spaced apart at distances of about 200 μm from each other and have an opening cross section of 50 μm. The holes of the perforation are, in particular, produced by means of laser perforating. The light exit face 3 is formed by means of the plate 12′″, wherein the holes of the perforation 16′″ are arranged at the edge of the light exit face 3 or slightly outside of the light exit face 3 so that the geometric figure of the perforation 16′″, though it is the same as or congruent to the geometric figure of the light exit face 3, is a little larger than the latter.

On the side facing the plate 12′″, the support plate 13′″ comprises a circumferential duct 17′″ into which the holes of perforation 16′″ open out. Via the bores 15′″ ending up in the circumferential duct 17′″, a depression 25′″ in the order of a vacuum is generated in the circumferential duct 17′″ and thus in the holes of the perforation 16′″. By this depression 25′″, the liquid glass is drawn into the partial mold 11′″.

Elements, dimensions and angles as used in FIGS. 3 to 9, respectively, have been drafted in consideration of simplicity and clarity and not necessarily to scale. For example, the orders of magnitude of some of the elements, dimensions and angles, respectively, have been exaggerated with regard to other elements, dimensions and angles, respectively, in order to enhance comprehension of the examples of embodiment of the present invention.

1.-32. (canceled)

33. A method for producing a solar concentrator from transparent material, the method comprising:
blank molding a transparent material for creating a solar concentrator having a light entry face, a light exit face, a light guide portion, and a support frame having an outer rim and being situated between the light entry face and the light exit face, wherein the light guide portion is restricted by a light guide portion surface between the light entry face and the light exit face,
wherein the molding of said material occurs between a first mold adapted for molding the light entry face and at least a second mold adapted for molding the light exit face, such that the outer rim is blank molded in a manner of at least one of out of contact with said mold and only partially in contact with a mold.

34. The method of claim 33, wherein the transparent material is drawn into the second mold by means of the depression (e.g. pressure below atmosphere) at least partially during said blank molding.

35. The method of claim 34, wherein the depression is at least 0.5 bar.

36. The method of claim 33, wherein immediately before molding, the transparent material has a viscosity of no more than 10^{4.5} (dPa)(s).

37. The method of claim 33, wherein the second mold comprises a concave portion for molding the light exit face as a convex light exit face

38. The method of claim 37, wherein the concave portion for molding the convex light exit face is curved with a radius of curvature of more than 30 mm.

39. The method of claim 37, wherein the concave portion for molding the convex light exit face is curved such that the maximum of the deviation of contour from the ideal plane of the mold is less than 100 μm.

40. The method of claim 37, wherein the concave portion for molding the convex light exit face is curved such that the maximum of the deviation of contour from the ideal plane of the mold is more than 1 μm.

41. The method of claim 33, wherein the second mold is an at least two-part mold.

42. A method for producing a solar concentrator from transparent material, the method comprising:
providing a first mold and at least a second mold,
drawing the transparent material into the at least second mold by means of a depression (e.g pressure below atmosphere), and
blank molding a transparent material for creating a solar concentrator having a light entry face, a light exit face, a light guide portion, and a support frame having an outer rim and being situated between the light entry face and the light exit face, wherein the light guide portion is restricted by a light guide portion surface between the light entry face and the light exit face, wherein molding the material occurs between the first mold and the at least second mold, such that the outer rim is blank molded in a manner of at least one of out of contact with said mold and only partially in contact with a mold.

43. The method of claim 42, wherein the depression is at least 0.5 bar.

44. The method of claim 42, wherein immediately before molding, the transparent material has a viscosity of no more than 10^{4.5} (dPa)(s).

45. The method of claim 42, wherein the second mold comprises a concave portion for molding the light exit face as a convex light exit face

46. The method of claim 45, wherein the concave portion for molding the convex light exit face is curved with a radius of curvature of more than 30 mm.

47. The method of claim 45, wherein the concave portion for molding the convex light exit face is curved such that the maximum of the deviation of contour from the ideal plane of the mold is less than 100 μm.

48. The method of claim 45, wherein the concave portion for molding the convex light exit face is curved such that the maximum of the deviation of contour from the ideal plane of the mold is more than 1 μm.

49. The method of claim 43, wherein the second mold is an at least two-part mold.
